(19) United States
(12) Patent Application Publication
(10) Pub. No.: US 2001/0028765 A1
(43) Pub. Date: Oct. 11, 2001

(54) Optical equalizer

(76) Inventors: Tomoaki Toratani, Tokyo (JP); Toshiro Yamamoto, Tokyo (JP); Mamichi Tuyuki, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/746,747

(22) Filed: Dec. 22, 2000

(30) Foreign Application Priority Data
Dec. 27, 1999 (JP) 11-369531

(51) Int. Cl. G02B 6/26

(52) U.S. Cl. 385/39; 385/27

(57) ABSTRACT

The present invention provides an optical equalizer comprising a body to which optical fibers can be connected, two or more lenses adapted to optically couple the optical fibers together, and two or more etalon filters held by two or more corresponding filter holders and having different free spectrum areas, and wherein, when the two or more filter holders are set in holder insertion holes of the body, respectively, the respective etalon filters held by the filter holders are installed substantially in cascade between the two or more lenses, and the respective filter holders set in the holder insertion holes can be rotated around rotation axes perpendicular to an optical axis independently, and, when the respective filter holders are rotated, planes defined by normal vectors of the two etalon filters held by the adjacent filter holders do not become parallel with each other.

### BACKGROUND OF THE INVENTION

1. Field of the Invention

As one of optical amplifiers used for amplifying an optical signal in long distance optical communication and the like, there is an optical amplifier using an erbium doped fiber (EDF). In the EDF used in the optical amplifier of this kind, as shown in FIG. 7, optical signal having a wavelength of about 1550 nm and pumping light having a wavelength of 1480 nm are inputted together, the optical signal is amplified and then outputted. However, since the optical amplifier using such EDF has a property that an amplifying ratio is varied with the wavelength of the inputted optical signal, gain of the outputted signal has wavelength dependency. In conception, when an optical signal having a property shown in a left side graph of FIG. 8 is inputted, output thereof will have a property shown in a right side graph of FIG. 8. Thus, normally, as shown in FIG. 9, a module 60 in which the greater the amplifying ratio of a wavelength of an EDF 50 the greater the loss and the smaller the amplifying ratio of the wavelength the smaller the loss (i.e., the loss depends upon the wavelength) is connected as a rear stage of the EDF 50 so that wavelength dependency of gain of optical signal outputted from the EDF 50 is cancelled to maintain a flat gain property. Such a module 60 for giving the loss depending upon the wavelength is called as an optical equalizer (or gain equalizer or gain flattening filter). The present invention relates to such an optical equalizer.

2. Related Background Art

As one of optical equalizers, there is an optical equalizer using an etalon filter (equalizer of etalon type). The equalizer of etalon type serves to give a desired loss property to the optical signal by passing the optical signal outputted from the EDF 50 shown in FIG. 9 through a single etalon filter 70 as shown in FIG. 10A or a plurality of etalon filters 70 having different loss properties regarding a light wavelength as shown in FIG. 10B. In such an equalizer, the loss property (Loss) given to the optical signal from the etalon filter(s) 70 can be sought from the following equation:

$$Loss = 10 \cdot log [ 1 + {m}_{1} \cdot {sin}^{2} ( \frac{2 \cdot π \cdot f}{2} \cdot {m}_{s} ) ] ( dB )$$

$$where$$

$${m}_{1} = \frac{4 \cdot R}{{( 1 - R )}^{2}}$$

$${m}_{s} = \frac{2 \cdot n \cdot d \sqrt{1 - \frac{{sin}^{2} θ}{{n}^{2}}}}{C}$$

and, variables in the above equations are as follows:

R: reflectance of surface of etalon filter;

f: frequency of etalon filter;

n: refractive index of etalon filter;

d: thickness of etalon filter;

θ: incident angle of optical signal on etalon filter; and

c: light velocity.

As apparent from the above equations, the loss property given to the light passed through the etalon filter by the etalon filter is determined by the thickness (d), refractive index (n), angle (0 ) with respect to an optical axis and reflectance (R) of the etalon filter.

Thus, when exemplary calculation is effected under the following condition:

R=0.1,

n=1.4,

d=50 μm,

θ=3°, and

wavelength of light=1530 to 1580 nm,

if the thickness (d) of the etalon filter has an error of 0.1 μm with respect to the design value, the loss property will generate maximum deviation of about ±1 (dB) from the design value. However, according to performance requirements of the optical equalizer, the allowable deviation is a half of the above-mentioned deviation or less. Thus, conventionally, during the assembling of the optical equalizer, the angle (θ) of the etalon filter was adjusted minutely to bring the deviation within the allowable range. In this case, by increasing the angle (θ) by about 3 degrees from the design value, the deviation can be reduced to about 1/10.

However, the conventional equalizers had the following disadvantage. That is to say, as a result that the angle of the etalon filter is adjusted during the assembling of the equalizer in order to bring the deviation (with respect to the design value) of the loss property within the allowable range, adjacent etalon filters (opposed surfaces of the adjacent etalon filters) may become parallel with each other. In such a case, resonant reflection of the optical signal is generated between the surfaces, with the result that, as shown in a graph of FIG. 11, the loss property with respect to the optical signal generates ripple. The reason is that, when it is assumed that a distance between the adjacent etalon filters is d2, the fact that the opposed surfaces of the adjacent etalon filters become parallel with each other creates the same condition as a condition that a new etalon filter having refractive index of 1 (refractive index of air) and a thickness of d2 is inserted between the adjacent etalon filters.

In tests using silica glass, when an effective diameter of the light beam is 500 μm, it was ascertained that ripple is not generated so long as an angle between upper and lower surfaces of glass is 0.2 degree or more. Thus, it can be guessed that the ripple is not generated unless the parallelism of the etalon filter is smaller than 0.2 degree.

### SUMMARY OF THE INVENTION

An object of the present invention is to provide an optical equalizer in which, even when angles of etalon filters are adjusted during assembling in order to suppress deviation of a loss property from a design value within an allowable range, there is almost not possibility that opposed surfaces of the adjacent etalon filters become parallel with each other.

According to a first aspect of the present invention, there is provided a first optical equalizer comprising a body to which two or more optical fibers can be connected, two or more lenses disposed within the body and adapted to optically couple the optical fibers together, and two or more etalon filters held by two or more corresponding filter holders and having different free spectrum areas, and wherein, when the two or more filter holders are set in holder insertion holes of the body, respectively, the respective etalon filters held by the filter holders are installed substantially in cascade between the two or more lenses, and the respective filter holders set in the holder insertion holes can be rotated around rotation axes perpendicular to an optical axis independently, and, when the respective filter holders are rotated, planes defined by normal vectors of the two etalon filters held by the adjacent filter holders do not become parallel with each other, or the shapes of the both planes do not become the same with each other.

According to a second aspect of the present invention, in the first optical equalizer, an angle defined between the rotation axes of the two adjacent filter holders assumes angles other than integral times of 180 degrees.

According to a third aspect of the present invention, in the first optical equalizer, an angle between rotation axes of two filter holders disposed on both sides of any one filter holder in a direction of the optical axis is set to zero.

According to a fourth aspect of the present invention, in the optical equalizer according to any one of first to third aspect, each of the etalon filters has a reflection substrate constituted by coating reflection films capable of partially reflecting light on both surfaces of a light permeable substrate and the reflection substrate has a thickness selected so that each of plural optical signals passed through the reflection substrate is subjected to predetermined loss depending upon a wavelength thereof.

### BRIEF DESCRIPTION OF THE DRAWINGS

FIG. 1 is a schematic view of an optical equalizer according to a first embodiment of the present invention;

FIG. 2A is a perspective view of the optical equalizer according to the first embodiment, and

FIG. 2B is a perspective view showing an example of a filter holder;

FIG. 3 is a perspective view showing a condition that the filter holders are installed in a body;

FIG. 4 is a sectional view taken along the line A-A in FIG. 3;

FIG. 5 is a perspective view of an optical equalizer according to a second embodiment of the present invention;

FIG. 6 is a perspective view of an optical equalizer according to a third embodiment of the present invention;

FIG. 7 is a schematic view showing a method for amplifying light by using EDF;

FIG. 8 is an explanatory view showing the fact that an amplifying ratio of EDF has wavelength dependency;

FIG. 9 is an explanatory view showing an example of means for removing wavelength dependency of gain in optical amplification effected by EDF;

FIGS. 10A and 10B are schematic views showing an principle of an optical equalizer of etalon type, where

FIG. 10A shows a case where a single etalon filter is used and

FIG. 10B shows a case where a plurality of etalon filters are used; and

FIG. 11 is a view showing ripple generated due to resonant reflection.

### DETAILED DESCRIPTION OF THE PREFERRED EMBODIMENTS

(First Embodiment)

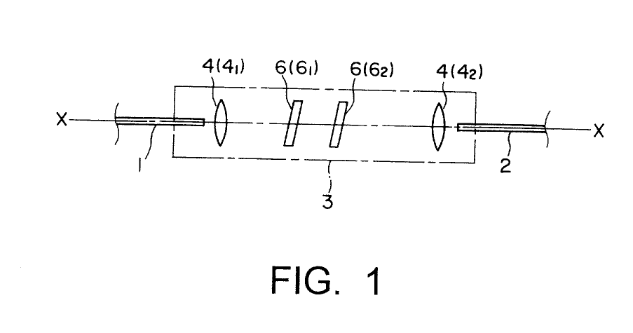

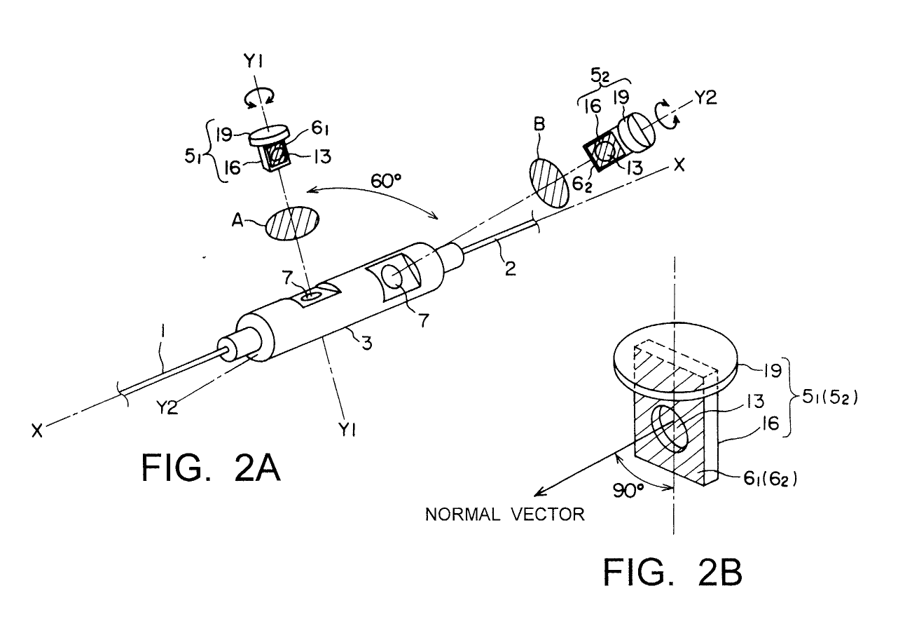

An optical equalizer according to a first embodiment will now be explained with reference to FIGS. 1 to 4. As shown in FIG. 1, the optical equalizer comprises a body 3 to which two optical fibers 1, 2 can be connected, two lenses 4₁, 4₂ disposed within the body 3 and adapted to optically couple the two optical fibers 1, 2 together, and two etalon filters 6₁, 6₂ disposed substantially in cascade between the lenses 4₁ and 4₂ while being held by filter holders 5₁, 5₂ (FIG. 2A).

As shown in FIG. 2A, the body 3 is formed as an elongated cylinder having a longitudinal one end to which the input optical fiber 1 can be connected and the other end to which the output optical fiber 2 can be connected. As shown in FIG. 2A, the body 3 is provided at its outer periphery with two holder insertion holes 7 into which the filter holders 5₁, 5₂ can be inserted, which two holes are formed along an optical axis X-X of light incident from the optical fiber 1 and coupled to the optical fiber 2 (optical signal collimated by the lenses 4 shown in FIG. 1). The holder insertion holes 7 are circular holes each having a centerline perpendicular to the optical axis X-X, and a centerline Y1-Y1 of one of the holder insertion holes 7 is deviated from a centerline Y2-Y2 of the other holder insertion hole 7 by 60 degrees in a circumferential direction of the body 3. Incidentally, the angle defined between two centerlines Y1-Y1 and Y2-Y2 is not limited to 60 degrees but may be any angle other than integral times of 180 degrees (including 0).

Two etalon filters 6₁, 6₂ shown in FIG. 1 have different free spectrum areas, and the rearward etalon filter 6₂ has a maximum loss value, minimum loss value and free spectrum area which are obtained by effecting Fourier progression expansion of a gain wavelength property of the an optical amplifier to which the optical equalizer is applied.

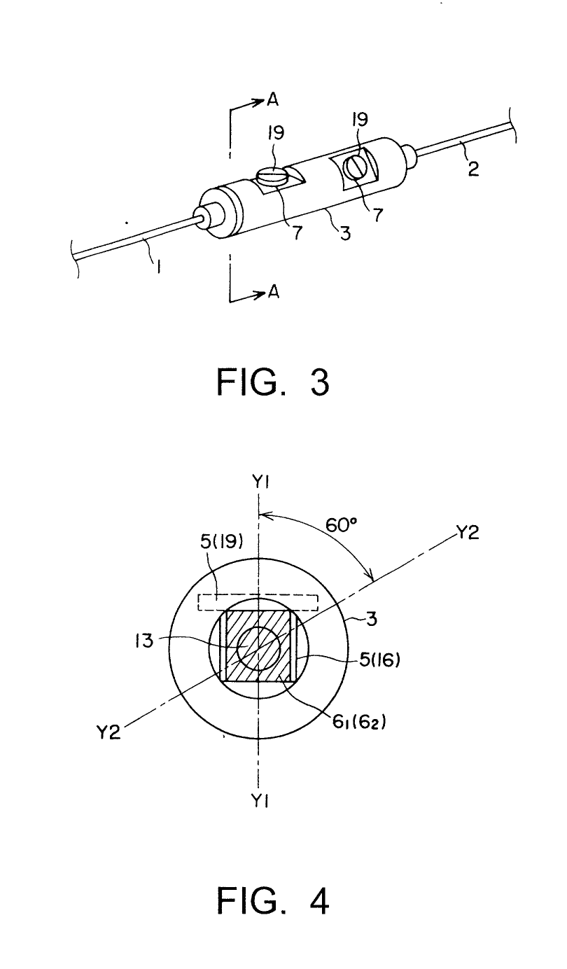

As shown in FIG. 2A, the etalon filters 6₁, 6₂ are held by the filter holders 5₁, 5₂, respectively and are installed within the body 3 in such a condition. As shown in FIG. 2B, each of the filter holders 5₁, 5₂ comprises a plate-shaped holding portion 16 including a hole 13 having a diameter greater than a beam diameter of the collimated optical signal, and a disc-shaped head portion 19 integrally formed with an upper end of the holding portion and engageable with a circumferential edge of the corresponding holder insertion hole 7 of the body 3. When the holding portions 16 to which the etalon filters 6₁, 6₂ are adhered as shown in FIG. 2A are inserted into the interior of the body 3 through the holder insertion holes 7, the head portions 19 are engaged by the circumferential edges of the respective holder insertion holes 7 as shown in FIG. 3, with the result that the etalon filters 6₁, 6₂ (etalon filter 6₁ is shown in FIG. 4) are installed within the body 3 at predetermined positions. Further, when the head portions 19 engaged by the circumferential edges of the respective holder insertion holes 7 are rotated around the centerlines Y1-Y1, Y2-Y2 of the insertion holes 7 in directions shown by the arrows in FIG. 2A, angles of the held etalon filters 61, 62 with respect to the optical axis X-X are adjusted. Since the two etalon filters 6₁, 6₂ are rotated independently around the two centerlines Y1-Y1, Y2-Y2 of the insertion holes 7 deviated from each other by 60 degrees, a flat plane A defined by a unit length normal vector (FIG. 2B) of the etalon filter 6₁ does not become parallel with a flat plane B defined by a unit length normal vector (FIG. 2B) of the etalon filter 61. That is to say, opposed surfaces of the etalon filters 6₁, 6₂ do not become parallel with each other. Although, the opposed surfaces become parallel with each other only when the opposed surfaces of the filters 6₁, 6₂ both become perpendicular to the optical axis X-X, such possibility does almost not occur.

(Second Embodiment)

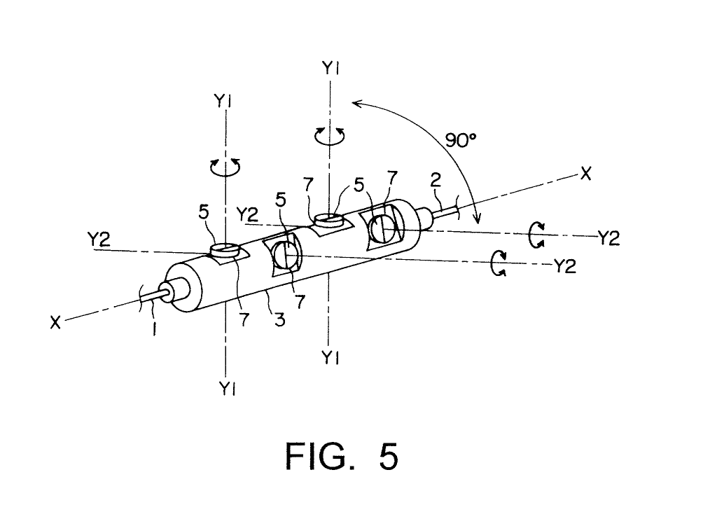

Next, an optical equalizer according to a second embodiment of the present invention will be explained with reference to FIG. 5. A fundamental construction of the equalizer according to the second embodiment is identical to that of the first embodiment shown in FIGS. 1 to 4. The difference is that four etalon filters (not shown) are installed substantially in cascade within the body 3. More specifically, as shown in FIG. 5, the body 3 is provided with four holder insertion holes 7 into which four filter holders 5 can be set. Centerlines of the four holder insertion holes 7 are staggered along the optical axis X-X with offset by 90 degrees in the circumferential direction, so that centerlines Y1-Y1 of longitudinal foremost (leftmost in FIG. 5) and third insertion holes 7 of the body 3 are in parallel with each other and centerlines Y2-Y2 of second and fourth holder insertion holes 7 are also in parallel with each other, but the centerlines Y1-Y1, Y2-Y2 of the adjacent holder insertion holes 7 do not become parallel with each other. In this case, although the centerlines Y1-Y1, Y2-Y2 of all holder insertion holes 7 may not be in parallel with each other, as shown in FIG. 5, when an angle between the centerlines Y1-Y1 and Y1-Y1 of two filter holders 5, 5 disposed on both sides of any one filter holder 5 in the direction of the optical axis X-X is selected to be zero (0), formation of the holder insertion holes 7 can be facilitated and application to other module having the different number of insertion holes 7 can be facilitated. Similar to the above, although the angle defined between the centerlines Y1-Y1 and Y2-Y2 is not limited to 90 degrees, when this angle is set to 90 degrees, PDL can be reduced.

(Third Embodiment)

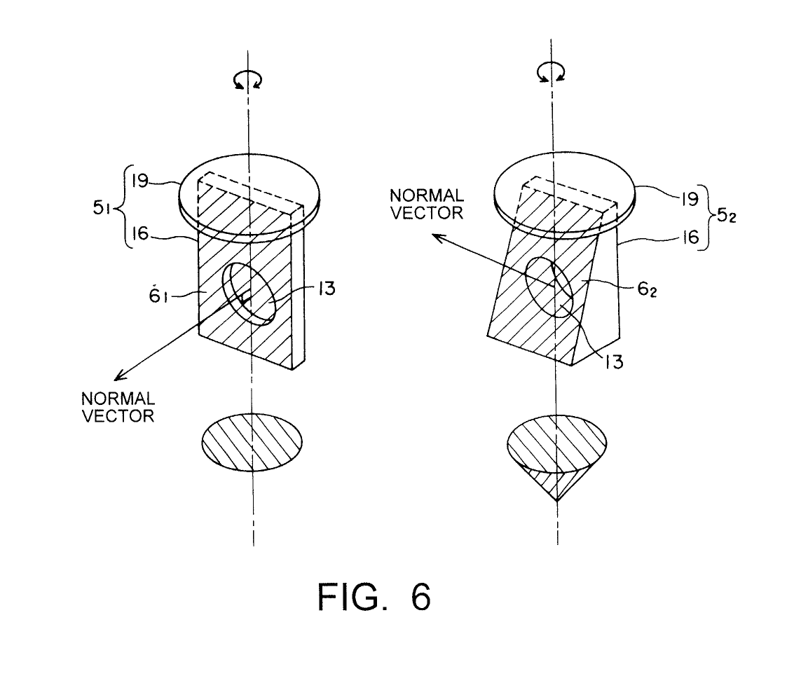

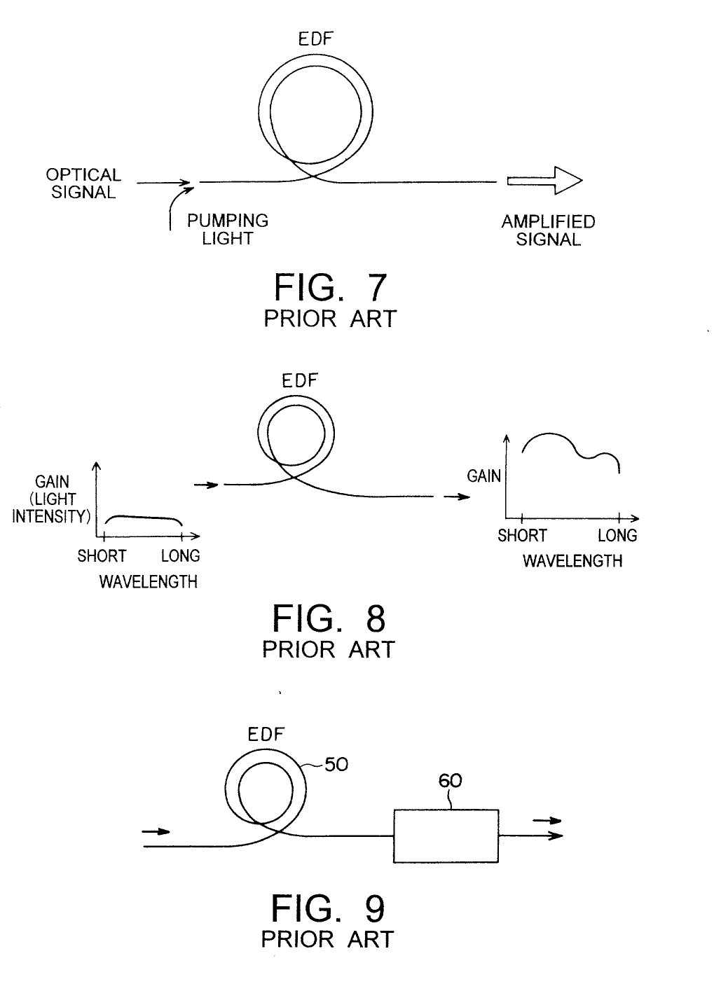

In order to ensure that the opposed surfaces of the etalon filters 6₁, 6₂ held by the respective holders 5₁, 5₂ do not become parallel with each other even when the filter holders 5₁, 5₂ shown in FIG. 2A are rotated, as shown in FIG. 6, configurations of holding portions 16 of two holders 5₁, 5₂ may be differentiated so that an angle defined between a unit length normal vector of the etalon filter 6₁ held by the holder 5₁ and a centerline of the filter holder 5, becomes 90 degrees and an angle defined between a unit length normal vector of the etalon filter 6₂ held by the other holder 5₂ and a centerline of the filter holder 5₂ becomes greater than 90 degrees. With this arrangement, when the etalon filter 6₁ is rotated, a plane defined by the unit length normal vector of the etalon filter 6₁ becomes a flat plane as shown in FIG. 6, and, when the etalon filter 6₂ is rotated, a plane defined by the unit length normal vector of the etalon filter 6₂ becomes a conical plane as shown in FIG. 6, thus the opposed surfaces of the etalon filters 6₁, 6₂ do not become parallel with each other. However, in order to ensure that the opposed surfaces of the etalon filters 6₁, 6₂ do not become parallel with each other after rotations of the etalon filters 6₁, 6₂, it is not necessarily required that the plane defined by the normal vector of the rotated etalon filter 6, becomes the flat plane and the plane defined by the normal vector of the rotated etalon filter 62 becomes the conical plane, but, so long as the shapes of these planes are different with each other, any planes may be achieved.

It is desirable that the etalon filters used with the optical equalizer according to the present invention each has a reflection substrate constituted by coating reflection films capable of partially reflecting light on both surfaces of a light permeable substrate and the reflection substrate has a thickness selected so that each of plural optical signals passed through the reflection substrate is subjected to predetermined loss depending upon a wavelength thereof.

In all of the above-mentioned embodiments, it should be understood that, after the angle adjustment was performed by rotating the filter holders, the filter holders are secured to the body to fix the etalon filters at the adjusted angle positions.

Industrial Availability

The optical equalizer according to the first aspect of the present invention provides the following advantages:

(1) Since the etalon filters held by the respective filter holders are located substantially in cascade between two or more lenses only inserting the filter holders into the holder insertion holes of the body, the optical equalizer of etalon type can be manufactured in a short time.

(2) Since the filter holders inserted into the corresponding holder insertion holes can be rotated independently around their rotation axes perpendicular to the optical axis, the angles of the etalon filters with respect to the optical axis can easily be adjusted minutely during the assembling.

(3) When the filter holders are rotated, since planes defined by the normal vectors of the etalon filters held by the adjacent holders do not become parallel with each other or coincide with each other, even when the etalon filters are rotated for angle adjustment, there is almost no possibility that the opposed surfaces of the adjacent etalon filters become parallel with each other which would occur resonant reflection.

The optical equalizer according to the second aspect of the present invention provides the following advantage:

(1) Since the angle defined between the rotation axes of the two adjacent filter holders inserted in the holder insertion holes is selected to become an angle other than integral times of 180 degrees, even when the filter holders are rotated, there is almost no possibility that the opposed surfaces of the adjacent etalon filters become parallel with each other which would occur resonant reflection.

The optical equalizer according to the third aspect of the present invention provides the following advantage:

(1) Since the angle between the rotation axes of the holders disposed on both sides of any one filter holder in the direction of the optical axis is selected to zero, the positions of the holder insertion holes may be staggered with the same angle along the direction of the optical axis, and thus, the holder insertion holes can easily be formed.

The optical equalizer according to the fourth aspect of the present invention provides the following advantage:

(1) Since each etalon filter has the reflection substrate constituted by coating the reflection films capable of partially reflecting light on both surfaces of the light permeable substrate and the reflection substrate has a thickness selected so that each of plural optical signals passed through the reflection substrate is subjected to predetermined loss depending upon a wavelength thereof, the plural optical signals having different wavelengths are subjected to predetermined losses depending upon wavelengths thereof, thereby easily maintaining the flat gain property.

What is claimed is:

1. An optical equalizer comprising:
a body to which two or more optical fibers can be connected;
two or more lenses disposed within said body and adapted to optically couple said optical fibers together; and
two or more etalon filters held by two or more corresponding filter holders and having different free spectrum areas; and wherein
when said two or more filter holders are set in holder insertion holes of said body, respectively, said etalon filters held by said filter holders are installed substantially in cascade between said two or more lenses, and said filter holders set in said holder insertion holes can be rotated around rotation axes (Y-Y) perpendicular to an optical axis (X-X) independently, and, when said filter holders are rotated, planes defined by normal vectors of said two etalon filters held by said adjacent filter holders do not become parallel with each other, or the shapes of the both planes do not become the same with each other.

2. An optical equalizer according to claim 1, wherein an angle defined between the rotation axes (Y-Y) of said two adjacent filter holders assumes angles other than integral times of 180 degrees.

3. An optical equalizer according to claim 1, wherein an angle between rotation axes (Y-Y) of two filter holders disposed on both side of any one filter holder in a direction of the optical axis (X-X) is set to zero.

4. An optical equalizer according to any one of claims 1 to 3, wherein each of said etalon filters has a reflection substrate constituted by coating reflection films capable of partially reflecting light on both surfaces of a light permeable substrate and said reflection substrate has a thickness selected so that each of plural optical signals passed through said reflection substrate is subjected to predetermined loss depending upon a wavelength thereof.
